(19) United States
(12) Patent Application Publication
(10) Pub. No.: US 2015/0375158 A1
(43) Pub. Date: Dec. 31, 2015

(54) INCREASED ONSTREAM TIME FOR CRYOGENIC SEPARATION PROCESSES

(71) Applicants: MARTIN LANG, Munich (DE); ANDREAS SELIGER, Munich (DE)

(72) Inventors: MARTIN LANG, Munich (DE); ANDREAS SELIGER, Munich (DE)

(21) Appl. No.: 14/549,610

(22) Filed: Nov. 21, 2014

Related U.S. Application Data
(60) Provisional application No. 61/908,803, filed on Nov. 26, 2013.

(51) Int. Cl. B01D 53/04

(52) U.S. Cl. CPC B01D 53/0407; B01D 53/0462; B01D 2253/104; B01D 2259/402; B01D 2259/416

(57) ABSTRACT

In a temperature swing adsorption (TSA) system upstream of a cold box, an apparatus for purifying a fluid, includes a chemisorption guard bed disposed between and in fluid communication with the TSA system and the cold box for removing impurities from the fluid. In a temperature swing adsorption (TSA) system including first and second adsorption vessels, and a cold box, the improvement includes a chemisorption guard bed disposed in at least one of the first and second vessels.

### BACKGROUND

The present embodiments relate to apparatus and methods for cryogenic separation processes.

During a cryogenic process, often operated within a “cold box”, a purification step occurs upstream of the cryogenic process for removal of carbon dioxide (CO₂), water (H₂O) and/or methanol (CH₃OH, often as MeOH) to a level less than 0.1 parts per million (ppm). The remaining content of impurities downstream of the temperature swing adsorption (“TSA”) vessels permits an operation of the cryogenic process for about two to three years, before the process has to be stopped in order to remove trapped impurities by a deriming process.

The standard onstream time of the cryogenic separation process is usually about two to three years. However, some projects require the onstream time of the process to be operational for up to five years.

Therefore, what is needed is a purification process downstream of the TSA for further removal of impurities so that the cryogenic separation process can operate for as long as up to five years before removal of trapped impurities (by deriming) is necessary.

Referring to FIG. 1, there is shown a purification process by a TSA for removing of CO₂, H₂O and/or CH₃OH. Such a process provides for purification to a level less than 0.1 ppm (parts per million) as installed upstream of the cold box for a cryogenic process. The purification process presents a problem for operators, wherein the cryogenic separation process must be continuous or “onstream” for a period greater than 3 years and up to as much as 5 years before removal of trapped impurities from the process is to occur.

### SUMMARY OF THIS INVENTION

There is provided herein a temperature swing adsorption (ISA) system upstream of a cold box, the TSA including an apparatus for purifying a fluid, and a chemisorption guard bed disposed between and in fluid communication with the TSA system and the cold box for removing impurities from the fluid.

The chemisorption guard bed is disposed upstream of the cold box, and may include an activated alumina adsorbent.

There is also provided a temperature swing adsorption (TSA) system including first and second adsorption vessels, and a cold box, wherein the improvement includes a chemisorption guard bed disposed in at least one of the first and second vessels.

The first and second adsorption vessels are disposed upstream of the cold box, and each guard bed includes an activated alumina adsorbent.

### BRIEF DESCRIPTION OF THE DRAWINGS

For a more complete understanding of the present embodiments, reference may be had to the following description taken in conjunction with the drawing Figures, of which:

FIG. 1 shows a schematic drawing of a known temperature swing adsorption (TSA) system upstream of a cold box for a cryogenic process;

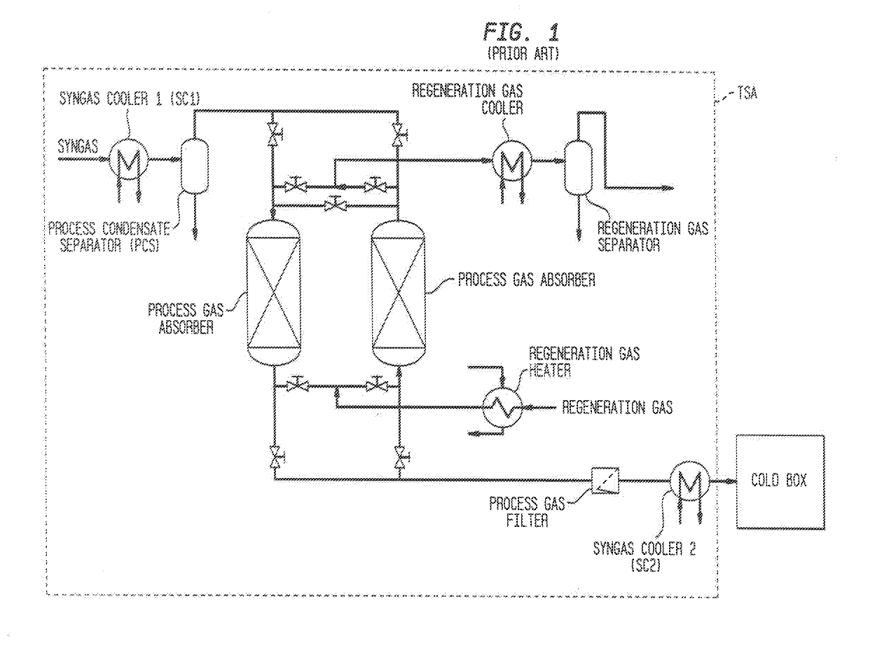

FIG. 2 shows a schematic drawing of a first embodiment of an apparatus according to the invention; and

FIG. 3 shows a schematic drawing of another embodiment of an apparatus according to the invention.

### DETAILED DESCRIPTION OF THE INVENTION

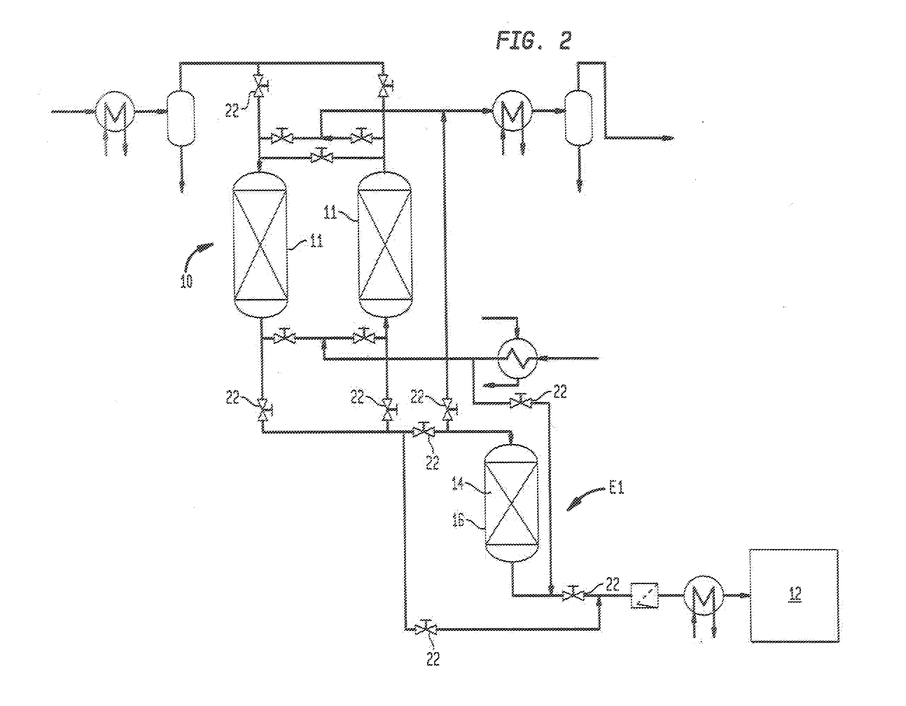

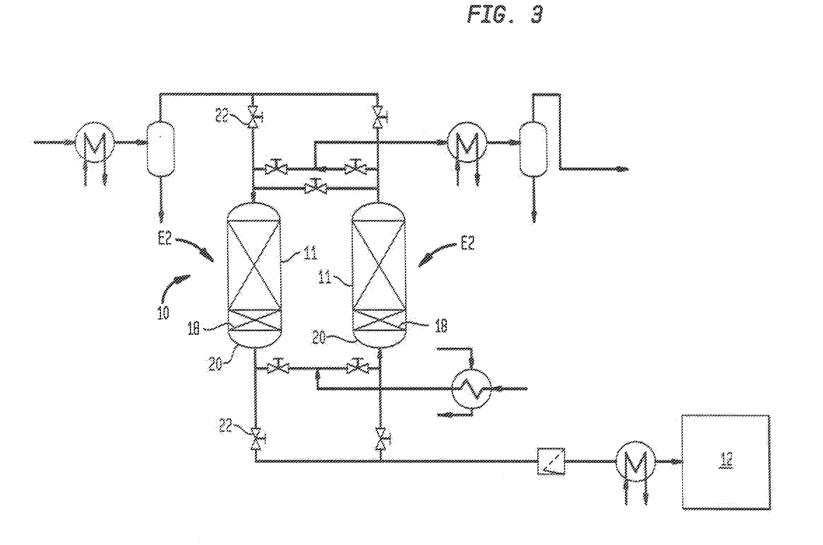

The apparatus embodiments of FIGS. 2 and 3 provide for ultra-purification within or downstream of the TSA apparatus 10 and upstream of the cold box 12 for further removal of impurities below the level of 0.1 ppm and in certain instances, down to a level of parts per billion (ppb), e.g. for CO₂ less than 30 ppb, by chemisorption in order to achieve an increased onstream time for the cryogenic separation process. Ultrapurification is considered to be accomplished with an activated alumina adsorbent.

Referring to the embodiment of FIG. 2, a chemisorption guard bed 14 is positioned in a separate vessel downstream 16 of the TSA vessels 11 and upstream of the cold box 12 as shown. The elements of the embodiment of FIG. 2 are indicated by E1.

In FIG. 3, a chemisorption layer 18 is disposed proximate a bottom 20 of one or both of the adsorber vessels 11 in the TSA. The elements of the embodiment of FIG. 3 are indicated by E2.

There is therefore provided herein for a temperature swing adsorption (TSA) apparatus having a cold box 12, an apparatus for purifying a fluid including a chemisorption guard bed 14 disposed between and in fluid communication with the TSA system and the cold box 12 for removing impurities from the fluid. The chemisorption guard bed 14 may be disposed upstream of the cold box 12.

There is also provided herein for a temperature swing adsorption (TSA) system having first and second adsorption vessels 11, and a cold box 12, an improvement including a chemisorption guard bed 18 disposed in at least one of the first and second vessels 11. The first and second adsorption vessels 11 may be disposed upstream of the cold box 12.

Valves 22 are provided as indicated for the various streams, although not all are indicated by reference numbers.

The arrangement of this apparatus with respect to the existing system can be provided with or without a regeneration mode. That is, without a regeneration mode, a guard bed has to be disposed; while having the regeneration mode permits the guard bed to be designed for an extended onstream time (e.g. 1-2 months), after which it has to be regenerated. Regeneration is with nitrogen (N₂) at elevated temperatures (approximately 270° C.) by use of high pressure steam or electrical heater). Either the regeneration system of the existing TSA is used and designed accordingly, or a separate regeneration system for the guard beds has to be installed and operated.

Run time for the chemisorption step can be lower than the required cryogenic separation run time by bypass operation for replacement of chemisorption filling or a second guard bed.

In the situation where the chemisorption layer is integrated in the TSA vessels, the adsorbent exchange can be managed by a three-adsorber system.

It will be understood that the embodiments described herein are merely exemplary, and that one skilled in the art may make variations and modifications without departing from the spirit and scope of the invention. All such variations and modifications are intended to be included within the scope of the invention as described and claimed herein. Further, all embodiments disclosed are not necessarily in the alternative, as various embodiments of the invention may be combined to provide the desired result.

What is claimed is:

1. In a temperature swing adsorption (TSA) system upstream of a cold box, an apparatus for purifying a fluid, comprising:
a chemisorption guard bed disposed between and in fluid communication with the TSA system and the cold box for removing impurities from the fluid.

2. The apparatus of claim 1, wherein the chemisorption guard bed is disposed upstream of the cold box.

3. The apparatus of claim 1, wherein the chemisorption guard bed comprises an activated alumina adsorbent.

4. In a temperature swing adsorption (TSA) system including first and second adsorption vessels, and a cold box, the improvement comprising:
a chemisorption guard bed disposed in at least one of the first and second vessels.

5. The apparatus of claim 4, wherein the first and second adsorption vessels are disposed upstream of the cold box.

6. The apparatus of claim 4, wherein the chemisorption guard bed comprises an activated alumina adsorbent.
